(19) United States
(12) Patent Application Publication
(10) Pub. No.: US 2025/0005460 A1
(43) Pub. Date: Jan. 2, 2025

(54) ENTITY MATCHING WITH JOINT LEARNING OF BLOCKING AND MATCHING

(71) Applicant: NEC Laboratories Europe GmbH, Heidelberg (DE)

(72) Inventors: Bin CHENG, Heidelberg (DE); Jonathan FUERST, Heidelberg (DE); Martin BAUER, Heidelberg (DE)

(21) Appl. No.: 18/292,372

(22) PCT Filed: Jul. 30, 2021
(86) PCT No.: PCT/EP2021/071471

§ 371 Date: Jan. 26, 2024

(51) Int. Cl. G06N 20/20

(52) U.S. Cl. CPC G06N 20/20

(57) ABSTRACT

A method of identifying entities from different data sources as matching entity pairs that refer to a same real-world object is provided. A set of labelling functions are provided to determine matching entities and non-matching entities of a source data set and a least one target data set. A subset of labelling functions are selected from the provided set of labelling functions for training machine learning models for a blocking module that aims at filtering out as many unmatched entity pairs as possible without missing any true matches and for a matching module that aims at predicting matching results for remaining entity pairs not filtered out by the blocking module. Both a blocking model for the blocking module and a matching model are jointly learned for the matching module based on available unlabeled entity pairs and the labelling functions of the selected subset of labelling functions.

### CROSS REFERENCE TO RELATED APPLICATIONS

This application is a U.S. National Phase application under 35 U.S.C. § 371 of International Application No. PCT/EP2021/071471, filed on Jul. 30, 2021. The International Application was published in English on Feb. 2, 2023 as WO 2023/006224 A1 under PCT Article 21(2).

### FIELD

The present invention relates to a method and a system of identifying entities from different data sources as matching entity pairs that refer to the same real-world object.

### BACKGROUND

Entity matching denotes the process of identifying those entities that are located in different data sources (e.g., CSV (comma-separated values) data files, websites, databases, knowledge bases, etc.), but refer to the same read world objects. Linking those matched entities together can create a more comprehensive and complete view out of multiple data sources to enable efficient decision-making in various business areas like public safety, smart city, e-Health etc.

Given any two data sources, one as the source data set S with a number of N₁ entities and the other as the target data set T with a number of N₂ entities, the entity matching process is to find all matched pairs (eᵢ, eⱼ), i.e. eᵢ and eⱼ referring to the same read world objects, where eᵢ belongs to S and eⱼ belongs to T. This matching problem is challenging mainly due to the following reasons:
1. The data sets S and T may be designed and used by different people in different domains and, usually, there is no common identification management strategies across those domains to refer to the same entity with the same unique ID.
2. eᵢ and eⱼ could have different data schemas with noisy or missing information, even though they refer to the same real world object, for example, with different attribute names and different attribute values.
3. The required computation overhead is high when both N₁ and N₂ are large numbers since its normal complexity is quadric (N₁×N₂). For datasets each having 1 million entities, it requires ˜10¹⁰ comparisons. If each comparison costs 0.05 msec, it is more than 13,889 hours in total.

Although different heuristic algorithms or learning-based approaches have been proposed, entity matching still remains to be an open issue when it is applied into actual data sets. First, there is no one-fits-all solution to entity matching due to the high diversity of data sets. Second, learning-based approaches are usually lack of a sufficient amount of labelled data in order to train an advanced classification model with good predication performance. Third, for a classification model that has been trained either with a large amount of existing labeled data via supervised learning or with lots of unlabeled data via weak supervision, their performance still cannot be guaranteed when being applying into new data sets.

### SUMMARY

In an embodiment, the present disclosure provides a method for identifying entities from different data sources as matching entity pairs that refer to a same real-world object. The method comprises: providing a set of labelling functions to determine matching entities and non-matching entities of a source data set and a least one target data set; selecting, from the provided set of labelling functions, a subset of labelling functions for training machine learning models for a blocking module that aims at filtering out as many unmatched entity pairs as possible without missing any true matches and for a matching module that aims at predicting matching results for remaining entity pairs not filtered out by the blocking module; and jointly learning both a blocking model for the blocking module and a matching model for the matching module based on available unlabeled entity pairs and the labelling functions of the selected subset of labelling functions.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic view illustrating an entity matching pipeline with selected input means based on predicted uncertainty in accordance with an embodiment of the present invention;

FIG. 2 is a schematic view illustrating a scheme of jointly training a blocking model and a matching model in accordance with an embodiment of the present invention;

FIG. 3 is a schematic view illustrating a scheme of uncertainty calculation and sample query for efficient active learning with regard to the error propagation of different phases and steps in the entire entity matching pipeline in accordance with an embodiment of the present invention;

FIG. 4 is a schematic view illustrating matching entity records for the same bridge in different system domains in accordance with an embodiment of the present invention; and

FIG. 5 is a schematic view illustrating entity matching to enable crime investigation for public safety in accordance with an embodiment of the present invention.

### DETAILED DESCRIPTION

In accordance with an embodiment, the present invention improves and further develops a method and a system of the initially described type in such a way that the effort and time required to identify all possible matches from two heterogeneous data sources is reduced.

In accordance with another embodiment, the present invention provides a method of identifying entities from different data sources as matching entity pairs that refer to the same real-world object, the method comprising providing a set of labelling functions to determine the matching entities and the non-matching entities of a source data set and a least one target data set; selecting, from the provided set of labelling functions, a subset of labelling functions for training machine learning models for a blocking module that aims at filtering out as many unmatched entity pairs as possible without missing any true matches and for a matching module that aims at predicting matching results for the remaining entity pairs not filtered out by the blocking module; and jointly learning both a blocking model for the blocking module and a matching model for the matching module based on the available unlabeled entity pairs and the labelling functions of the selected subset of labelling functions.

In accordance with another embodiment, the present invention provides a corresponding system comprising one or more processors that, alone or in combination, are configured to provide for execution of a method of identifying entities from different data sources as matching entity pairs that refer to the same real-world object, and by a corresponding tangible, non-transitory computer-readable medium having instructions stored thereon which, upon being executed by one or more processors, alone or in combination, provide for execution of a method of identifying entities from different data sources as matching entity pairs that refer to the same real-world object.

According to the invention it has first been recognized that matching entities from one domain to another domain is a crucial task in order to integrate and link different data sources, but that it is also costly and time-consuming since existing approaches may require lots of human effort to tune and select various thresholds and algorithms in such a data integration task. To address these issues, embodiments of the present invention include a machine learning based approach to entity matching by jointly generating and optimizing the blocking model and the matching model with minimal user annotated inputs. The approach can help to achieve optimal F₁ score with minimal user annotation effort.

According to an embodiment of the invention, the present invention provides a method for identifying the entities from different data sources that refer to the same real-world object, the method comprising the step of providing labelling functions that determine the matches and non-matches between the source data set and the target data set. All labelling functions, i.e. both the ones available from the beginning and the ones added during execution of the matching process, may be saved into a labelling function repository.

According to an embodiment, the labelling functions may include two types of labelling functions for the machine learning based on data programming. For instance, the labelling functions may be based on different types of domain knowledge and may include pair-wise labelling functions and set-wise labeling functions. The pair-wise labelling function may determine whether a given entity pair (eᵢ, eⱼ) is matched or not, or unknown as abstain, while the set-wise labelling function may directly compare the source data set and target dataset for all entity pairs.

According to an embodiment, the system includes a labelling function selection module that is configured to select a near-optimal subset of labelling functions for the model generation, i.e. for training blocking and matching models, for instance via weak supervision, based on their ranked F₁ scores over a small set of entity pairs annotated by domain experts. Instead of the F₁ scores, any other suitable performance characteristics may be used.

According to an embodiment, the system includes a joint learning module configured to apply a machine learning process to jointly learn a machine learning model for both the blocker module and the matcher module, based on available unlabeled entity pairs and also the selected labelling functions. By this manner of jointly generating a blocking model and a matching model for the entity matching pipeline, the best performance in terms of F₁ score can be achieved. For instance, the joint learning module may be implemented as a weakly supervised joint learning module configured to apply a weak supervision process to jointly learn the machine learning models.

According to embodiments, the learned blocking model may be applied by the blocking module to filter out false matches and pass the remaining entity pairs to the matching module. The matching module may then apply the learned matching model to predict the matching results of the entity pairs received from the blocking module.

According to an embodiment, user inputs (e.g. from a domain expert) may be requested based on a collective sample set selected from different steps with regards to error propagation of the entity matching pipeline. In this context, it may be provided that the uncertainty of all entity pairs in both the learning phase and prediction phase is estimated by means of an uncertainty estimation module that receives all prediction results from the joint learning module as well as the results from the blocking and matching modules. The uncertainty estimation module may then jointly select a few entity pairs with high uncertainty from each phase (model generation phase and result prediction phase) and different steps (blocking step and matching step). For these selected entity pairs, user annotation (i.e. labels) may be requested from the domain expert(s).

Generally, interaction with domain expert(s) may relate to any of the following options: a) to add new labelling functions; b) to annotate the entity pairs selected as described above; c) to display final predicted matches.

Embodiment of the present invention provide the following advantages:
1) Largely reducing the required effort and time to identify all possible matches from two heterogeneous data sources with automated and efficient model learning and labelling function selection;
2) Increasing the F₁ score of the prediction results with the collaborative blocking and matching models that are jointly learned, e.g. based on weak supervision or based on any other suitable machine learning approach;
3) Reducing the required annotation effort to achieve the same or even better prediction results. In this context, embodiments of the invention assume that when the domain experts may be required to provide a set of labelling functions based on existing domain knowledge or existing methods from the state of the art, they should be able to annotate the entity pairs with better accuracy.

Embodiments of the invention can be suitably applied, for instance, in the context of data integration and/or data enrichment services in any enterprise, commercial and/or public knowledge bases.

There are several ways how to design and further develop the teaching of the present invention in an advantageous way. To this end it is to be referred to the dependent claims on the one hand and to the following explanation of preferred embodiments of the invention by way of example, illustrated by the figure on the other hand. In connection with the explanation of the preferred embodiments of the invention by the aid of the figure, generally preferred embodiments and further developments of the teaching will be explained.

According to some prior art approaches for entity matching, given two data sets (hereinafter sometimes denoted source data set and target data set), a conventional entity matching pipeline includes two main modules: a blocker (or blocking module) that tries to quickly discard the entity pairs unlikely to be matched, and a matcher (or matching module) that attempts to identify true matched entity pairs. In principle, the blocker should filter out as many unmatched pairs as possible without missing any true matches via some lightweight computation and then leave the rest for the matcher to further check with more advanced algorithms that are more computation intensive.

Furthermore, active learning has been proposed as a new approach of collecting a small set of labelled pairs to bootstrap a learning-based entity matching and make it adapted to any new data sets. However, the current active learning-based approaches to entity matching have the following limitations: 1) their strategy of selecting new samples to query user's feedback does not consider the predication uncertainty and error introduced by different factors and different phases of the entity matching pipeline; 2) they face the cold start problem because their classification models for calculating uncertainty are learned from only a limited number of annotated samples and they could not utilize the unlabeled data even though a large number of unlabeled data is available; 3) so far, the blocking model and the matching model are learned in a separate way, but the accuracy of predicted matches actually depends on both steps; 4) they ignore the time limit of retraining the classification models and calculating the next round of query samples based on newly provided user inputs. If the required computation time of retraining and re-calculating is long, like minutes or hours, it will be insufficient to interact with the users, because a short response time may be required by the users to provide further inputs.

Embodiments of the present invention address at least some of the above issues.

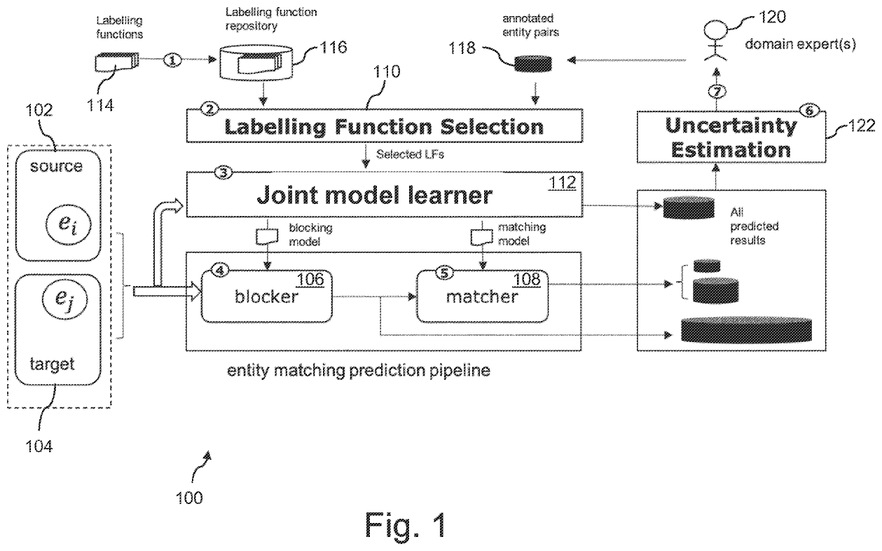

FIG. 1 shows an entity matching pipeline 100 in accordance with an embodiment of the present invention, which introduces a novel approach of identifying all matched entities between two or more (typically large) data sets, namely a source data set 102 and a target data set 104, that are provided from different sources. As illustrated in FIG. 1, the embodiment adds some extra components on top of the traditional entity matching pipeline (including blocking module 106 and matching module 108) to speed up the entire process of finding more matched entities with less time.

In brief, the entity matching pipeline 100 according to an embodiment of the invention comprises as an additional component a labelling function selection module 110, as shown in FIG. 1. The labelling function selection module 110 is configured to fast select a near-optimal set of provided labelling functions based on a small number of entity pairs annotated by the domain experts. As another additional component, the entity matching pipeline 100 may include a joint learning module 112 used to train or retrain a machine learning model for both the blocker and matcher modules 106, 108 by using a few annotated entity pairs, a large amount of unlabeled data, and selected labelling functions, as will be explained in more detail hereinafter.

As shown at step 1 in the upper left of FIG. 1, a set 114 of labelling functions is provided, wherein a labelling function is, in general, a function that outputs a label for some subset of a dataset, e.g. yes/no, positive/negative, matching/non-matching (in case of binary decisions), or, e.g., a number (in case of multinominal decisions). In the present case, the labelling functions are designed to determine the matching entities and the non-matching entities of the source data set 102 and the target data set 104. The provided labelling functions 114 may be stored in a labelling function repository 116.

According to an embodiment of the invention, the set 114 of labelling functions may include two types of labelling functions that determine the matches and non-matches between the source data set 102 and the target data set 104 based on different types of domain knowledge: pair-wise labelling functions and set-wise labeling functions. They may all be used as a programmable function to determine how the entities in the source data set 102 can be matched with the entities in the target data set 104, via the comparison at different levels. The pair-wise labelling function is to determine whether a given entity pair (ei, ej) is matched or not, or unknown as abstain. The set-wise labelling function is to directly compare the source data set 102 and target data set 104 for giving its answers to all entity pairs. Labelling functions can be provided based on some existing heuristic distance-based matching algorithms, attribute-based hash functions, or any existing entity matching models.

Labelling functions can be provided initially or added later during the interaction with domain experts. The labelling function repository 116 may be updated accordingly to always save and maintain all available labelling function.

According to an embodiment of the invention, as shown at step 2, the labelling function selection module 110 may select, from the set 114 of labeling functions stored in the labelling function repository 116, a near-optimal subset of labelling functions for training blocking and matching models, for instance via weak supervision, based on entity pairs 118 annotated with labels. The annotations may have been provided by domain experts based on domain knowledge.

In this context, it is noted that each labelling function (LF) provides a weak signal to judge whether a given entity pair is matched or not, either at the entity pair level or at the set pair level. In the state of the art, Snorkel provides a data programming approach of utilizing a set of labelling function to train a generative model for producing weak labels and then use the produced weak labels to train a discriminative machine learning model for generalized prediction. This provides a potential solution to address the cold start problem with active learning, but directly applying this data programming approach would not lead to a good result, because the provided labelling functions could be very noisy and in practice it is not feasible to assume that every provided labelling function can make positive contribution on labelling the unlabeled entity pairs.

It is very time-consuming to explore all possible combinations of labelling functions because the total number of combinations is huge (˜2^{k}, k is the total number of labelling functions). To address this issue, embodiments of the invention provide an efficient selection mechanism to fast select a near-optimal set of labelling functions from the labelling function repository 116 based on the set of entity pairs 118 annotated with labels. Here, the set of annotated entity pairs 118 can be very small compared to the total number of unlabeled entity pairs available from the source and target data sets 102, 104.

According to an embodiment, the selection mechanism may include calculating an expected performance characteristics of each LF over the annotated data set 118. For instance, the performance characteristics may be the expected metrics F₁ score. Next, all LFs may be ranked based on their calculated F₁ scores (or any other significant performance characteristics) in descending order. From this ranked list, the top-n (e.g., with n=3) LFs may be selected as the initial LF set (LFS).

Next, the selected LFs (i.e. the set LFS) may be utilized to train a generative model, and the F₁ score (or any other significant performance characteristics) achieved by the generative model based on the selected LFs (LFS) over the annotated data set may be calculated.

In a subsequent step, the next LF (LF next) from the ranked list may be taken and then the F₁ score (or any other significant performance characteristics) achieved by a new generative model based on the new LF set {LFS+LFₙₑₓₜ} may be recalculated. If the F₁ score increases, LFₙₑₓₜ may be added into the selected LF set (LFS), and the process may continue to explore the next LF in the ranked list. Otherwise, the process may stop and may consider the current LFS as the final selected LF set.

According to an alternative embodiment, when there are no annotated entity pairs provided by a domain expert at the beginning, a naïve selection approach may be used, for example, simply taking all LFs available in the labelling function repository 116 or randomly selecting a fixed number of LFs from the repository 116.

According to an embodiment of the invention, as illustrated at step 3 in FIG. 1, a machine learning process may be applied to jointly learn two co-related machine learning models, one for the blocker module 106 and the other for the matcher module 108, based on available unlabeled entity pairs and also the selected labelling functions.

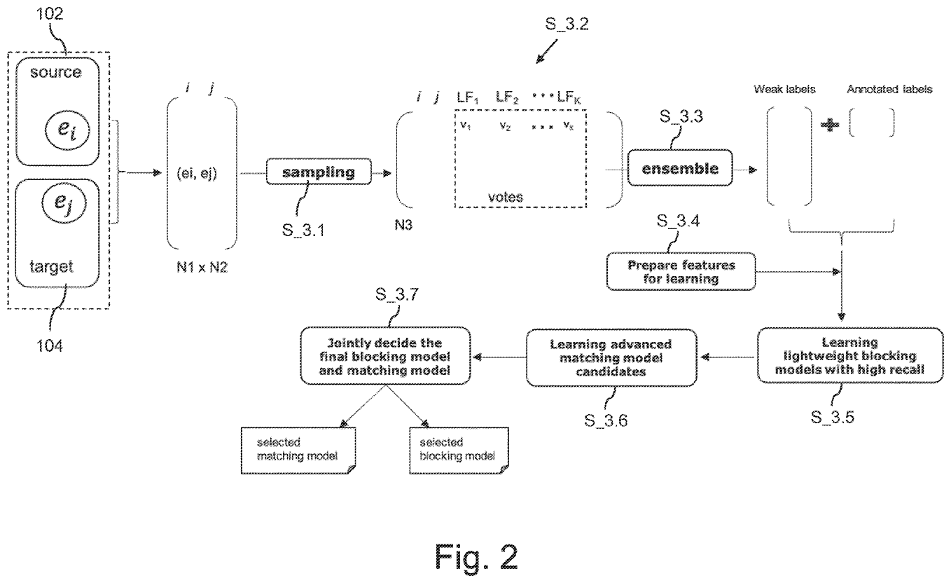

FIG. 2, in which like reference numbers denote like components as in FIG. 1, is a schematic view illustrating a scheme of jointly training a blocking model and a matching model, for instance via weak supervision, in accordance with an embodiment of the present invention. The illustrated embodiment aims at implementing above-mentioned step 3 of FIG. 1 in a way that enables a more efficient model learning process with all unlabeled entity pairs.

According to the illustrated embodiment, step 3 may be implemented to include a sub-step of sampling all entity pairs (cf. step S_3.1 in FIG. 2) to construct a roughly balanced data set using the selected labeling functions. Initially, this can be done with a randomly selected labelling function when no labelled entity pairs are available (e.g., entity pairs labelled by a domain expert). Once some labelled entity pairs are available (e.g., collected from the domain expert), they can be used to select a suitable labelling function as the sampling function that is computationally lightweight but with highest pair coverage and highest precision. In this case, most of true matches could be captured in the selected samples (N₃<<N₁×N₂, as shown in FIG. 2) for the next step to learn machine learning models for more generalized blocking and matching.

Next, as shown at step S_3.2 in FIG. 2, all selected labelling functions (denoted LF₁, . . . , LF_{K}) may be applied to generate the votes, which are the prediction results given by each labelling function, for the selected entity pairs. Based thereupon, as shown at step S_3.3, a weak label may be generated for all selected entity pairs by ensembling the votes from all selected labeling functions.

As shown at step S_3.4, the learning features of all selected entity pairs may be prepared for model training/retraining. Based thereupon, as shown at step S_3.5, a set of light-weight blocking model candidates may be learned with high recall and acceptable precision with all weak labels and also the annotated labels, e.g., as provided by the domain expert during the active learning phase (see step 7 in FIG. 1, which will be described in detail further below).

Next, as shown at step S_3.6 in FIG. 2, a set of advanced matching model candidates with high F₁ score may be learned based on the data set filtered by a given blocking model candidate. Based thereupon, as shown in step S_3.7, a joint decision can be made to select a blocking model and a matching model that can jointly produce the highest F₁ score for the final prediction result.

Overall, step 3 could be time-consuming since it involves several machine learning model training processes. However, the overall computation overhead has been largely reduced by applying a selected blocking model before training a matching model. According to embodiments of the invention, step 3 can be triggered when the entity matching pipeline 100 initially starts and when the set of labeling functions is changed. If there are already some machine learning models generated for the blocker 106 and matcher 108, step 3 will not block the entire process and the pipeline 100 can go on to the next step while the training process is still ongoing. The only effect is that the updated blocking model and matching model will take effect only in a next round.

According to an embodiment of the invention, the blocking module 106 may be configured to apply the selected blocking model to filter out false matches (as indicated at step 4 in FIG. 1). The remaining entity pairs may be passed to the matching module 108.

According to an embodiment of the invention, the matching module 108 may be configured to apply the selected matching model to predict the matching results of the entity pairs received from the blocking module 106 (as indicated at step 5 in FIG. 1).

According to embodiments of the invention, the entity matching prediction pipeline 100 may include an uncertainty estimation module 122. Generally, this module 122 may be configured to estimate the uncertainty of all entity pairs in both the learning phase and prediction phase and then jointly select a few entity pairs with high uncertainty from each phase/step to get user annotations (as indicated at step 6 in FIG. 1).

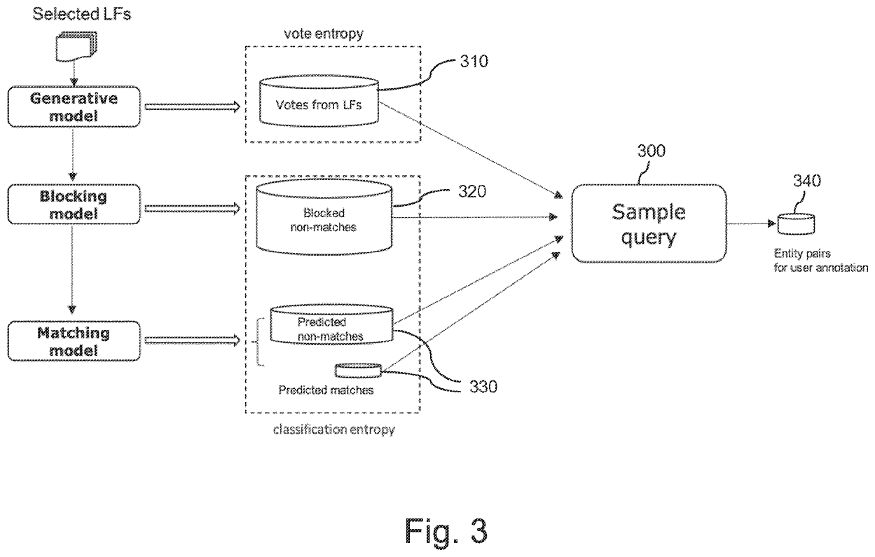

As described above, the entire entity matching pipeline 100 involves multiple phases (including a model learning phase and a prediction phase) and also multiple steps (including blocking and matching). The final results (i.e. the matches predicted by the matching module 108 in the entity matching pipeline 100) are affected by the error and noise that occur in all the phases and steps. Therefore, embodiments of the present invention provide a scheme of uncertainty calculation and sample query for efficient active learning with regard to the error propagation of different phases and steps in the entire entity matching pipeline 100, as schematically illustrated in FIG. 3.

According to an embodiment of the invention, a collective approach is used to query samples (as indicated at 300 in FIG. 3) based on uncertainty from three parts:
1) The voted results produced by selected labelling functions during the model generation phase and their uncertainty is calculated based on vote entropy, as indicated at 310;
2) The blocked non-matches predicted by the blocking model 106 during the prediction phase and their uncertainty is calculated based on classification entropy, as indicated at 320;
3) The predicted matches and non-matches classified by the matching model during the prediction phase and their uncertainty is also calculated based on classification entropy as indicated at 330.

This approach can provide a good tradeoff to adjust or correct the possible error introduced by all different phases and steps so that the overall results can be further improved and adjusted by user annotations (as indicated at 340) over the selected samples in the next round.

As shown at step 7 in FIG. 1, the uncertainty estimation module 122 may be configured to interact with a domain expert 120.

According to an embodiment, this interaction may include the option of adding new labelling functions. With this option, the domain expert 120 can add a new labelling function into the labelling function repository 116. The new labelling function may be taken into account by the labeling function selection module 110 and the joint model learner 112 to improve the way of generating the blocking model and the matching model in a next round.

Additionally or alternatively, the interaction may include the option to annotate the entity pairs selected by the uncertainty estimation module 122 at step 6. With this option, the domain expert 120 may be asked to provide the annotation for the selected samples. The provided annotations may be taken into account by the labeling function selection module 110 and the model learner 112 to improve the way of generating the blocking model and the matching model.

Still further, the interaction may include the option to check the final results that include all predicted matches and also all annotated matches. With this option, the predicted matches classified by the matcher 108 in the entity matching pipeline 100 may be displayed to the domain experts 120 as the final results, which could be further utilized to link or deduplicate the same entities across different system domains and further trigger some timely decisions in specific use cases.

Hereinafter, three particularly suitable application scenarios of the present invention will be described in some more detail. While a first application scenario relates to preventive disaster management in cities, a second application scenario relates to crime investigation for public safety, and a third one to automated building operation. As will be appreciated by those skilled in the art, the mentioned application scenarios are described merely illustrative and by way of example only. Effectively, many more different use cases can be envisioned.

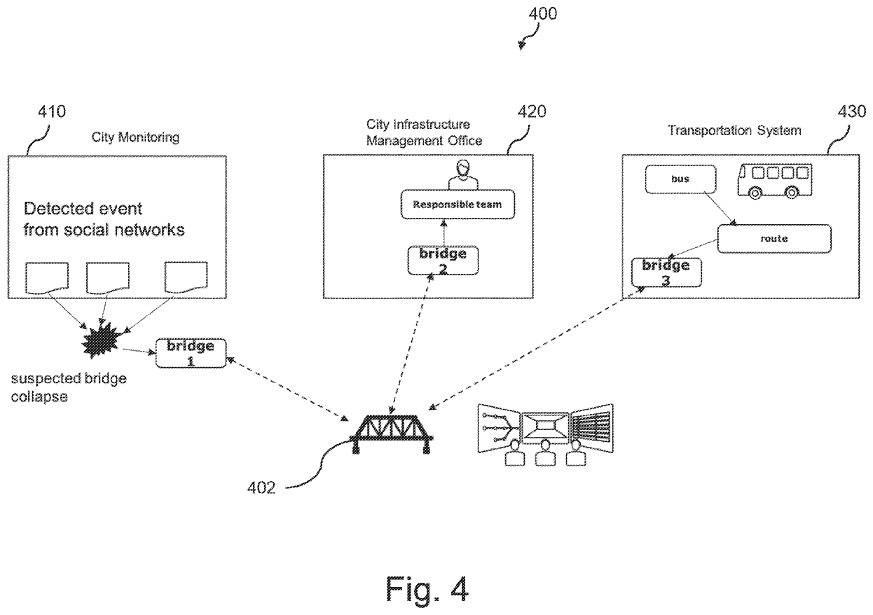

According to the first mentioned application scenario, embodiments of the present invention provide a solution for preventive disaster management with matched entities across domains of a smart city 400, as schematically illustrated in FIG. 4. In this context, one of the biggest challenges to enable smart city is to match and link heterogeneous information from various city domains together so that a more complete view of all city objects can be monitored to make timely decisions. For example, different information related to the same city infrastructure, e.g., a bridge 402, might be distributed in different sub-systems: a city monitoring system 410 (referring to bridge 402 as ‘bridge 1’) that is detecting possible disaster events from the social networks, a city infrastructure management system 420 (referring to bridge 402 as ‘bridge 2’) that remains all contact information of responsible team for examining and repairing service, and a transportation system 430 (referring to bridge 402 as ‘bridge 3’) that manages the routing information of all city buses. With highly accurate and automated entity matching, the relevant information of the same bridge 402 in all of these three subsystems 410, 420, 430 can be matched together to allow the city authorities to prevent and manage such potential disasters quickly and efficiently. For example, with the identified matches of the same bridge 402 across these three sub-systems 410, 420, 430, once a suspected bridge collapse is detected from the city monitoring system 410, the city authority can inform the responsible team of the city infrastructure management system 420 to have a fast check and also inform the connected transportation system 430 to have the city busses to stop or change their regular route so that a potential disaster could be avoided.

Generally, the applicable use cases of the present invention as disclosed herein in the smart city domain 400 are rather broad and not limited by the bridge related disaster prevention. By linking the information of same real-world objects from different data sources, an entity matching method in accordance with the embodiment of the invention can be used to trigger timely maintenance/examination actions of many other city infrastructures in various emergency situations, for example, examining office buildings or shopping malls in time to prevent fire hazard, checking road damage in time to prevent car accidents, examining the health of dams and water level in time to avoid the flood risk, etc.

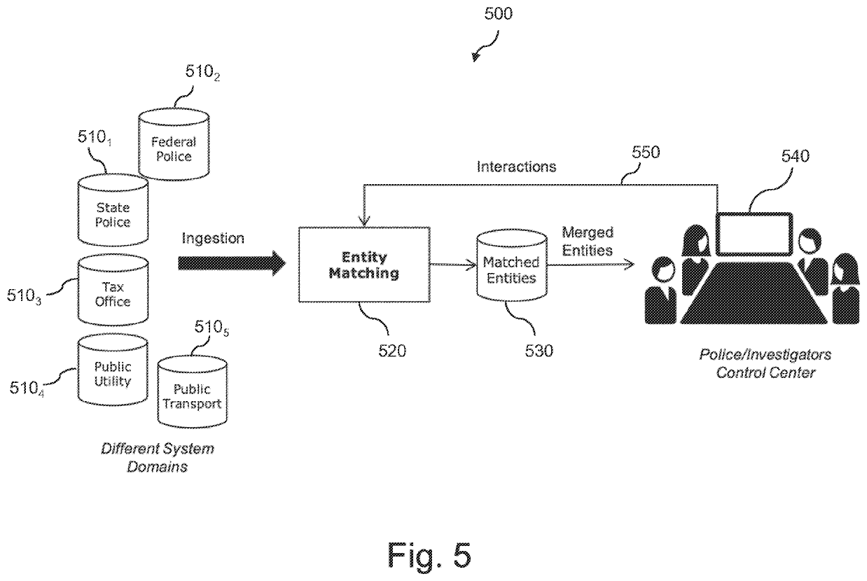

According to the second application scenario mentioned-above, embodiments of the present invention provide a processing scheme 500 for crime investigation with matched records across different system domains for public safety, as schematically illustrated in FIG. 5. In this context, a major problem in crime investigations is that data records for entities, such as a suspected criminal, are stored in different system domains 510 and governmental siloes with different data models and naming. E.g., there are police records on a local level, a state level 5101 and on a federal level 5102. Further, the tax office 5103, the public utility 5104, public transport company 5105, etc. might have further relevant records for the same entity.

Currently, this is slowing down criminal investigations, as data records need to be manually obtained and integrated. Embodiments of the present invention enable an automated entity matching, following the methods disclosed herein. Accordingly, it is possible to automatically display matched data records 530 for the same entity on an output device, such as a police/investigator control center 540, while quickly enabling investigators to adapt the entity matching system 520 to their needs, as indicated at 550 in FIG. 5.

According to the third application scenario mentioned-above, embodiments of the present invention provide a solution for improved automated building operation based on entity matching. In this context, non-residential buildings usually contain several controllable sub-systems, in form of a Building Management System (BMS). I.e., there will be different, often non-integrated systems to control the lights, heating, ventilation and cooling (HVAC) and access control. Further there are sub-systems for meeting room bookings, vacation requests etc. All these subsystems usually have a different data model. For example, a room entity will be modelled different (e.g., use a different name). Using automated entity matching according to the embodiments described herein, it is possible to integrate these data record for the same entity. This enables an automated building control system to better control various building aspects. E.g., room temperature and ventilation can be lowered when a meeting room is not used, the heating and lights for an office where the employees are on holidays can be turned down, etc. Such actions can have a significant impact, in particular in terms of CO₂ and cost reductions, considering that building account for around 40% of all energy consumed in developed countries.

Many modifications and other embodiments of the invention set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A method of identifying entities from different data sources as matching entity pairs that refer to a same real-world object, the method comprising:
providing a set of labelling functions to determine matching entities and non-matching entities of a source data set and a least one target data set:
selecting, from the provided set of labelling functions, a subset of labelling functions for training machine learning models for a blocking module that aims at filtering out as many unmatched entity pairs as possible without missing any true matches and for a matching module that aims at predicting matching results for remaining entity pairs not filtered out by the blocking module; and
jointly learning both a blocking model for the blocking module and a matching model for the matching module based on available unlabeled entity pairs and the labelling functions of the selected subset of labelling functions.

2: The method according to claim 1, further comprising: applying the learned blocking model to filter out unmatched entity pairs; and passing the remaining entity pairs to the matching module.

3: The method according to claim 2, further comprising: applying the learned matching model to predict the matching results of the entity pairs received from the blocking module.

4: The method according to claim 1, wherein the selection of the subset of labelling functions is based on-performance characteristics of the machine learning model achieved over a subset of entity pairs annotated with labels based on domain knowledge.

5: The method according to claim 4, wherein an achieved F₁ score of the machine learning model is taken as the performance characteristics used for selecting the subset of labelling functions.

6: The method according to claim 1, wherein the provided set of labelling functions comprises at least two types of labelling functions, comprising a pair-wise labelling functions determining a matching status of individual entity pairs and a set-wise labelling functions determining a matching status of all entity pairs of a given data set.

7: The method according to claim 1, further comprising:
estimating an uncertainty of all entity pairs in both a learning phase and a prediction phase:
jointly selecting a number of entity pairs with an uncertainty exceeding a predefined threshold from both a model generation phase and a prediction phase and from both the blocking module and the matching module; and
requesting user annotations for selected entity pairs from a domain expert.

8: The method according to claim 1, further comprising:
interacting with a domain expert to add new labelling functions, to annotate selected entity pairs, and/or to display the final predicted matches.

9: The method according to claim 1, further comprising saving all available labelling functions into a repository.

10: A system comprising one or more processors that, alone or in combination, are configured to provide for execution of a method of identifying entities from different data sources as matching entity pairs that refer to a same real-world object, the method comprising:
providing a set of labelling functions to determine matching entities and non-matching entities of a source data set and a least one target data set;
selecting, from the provided set of labelling functions, a subset of labelling functions for training machine learning models for a blocking module that aims at filtering out as many unmatched entity pairs as possible without missing any true matches and for a matching module that aims at predicting matching results for remaining entity pairs not filtered out by the blocking module; and
jointly learning both a blocking model for the blocking module and a matching model for the matching module based on available unlabeled entity pairs and the labelling functions of the selected subset of labelling functions.

11: The system according to claim 10, wherein the blocking module is further configured to apply the learned blocking model to filter out unmatched entity pairs, and to pass the remaining entity pairs to the matching module.

12: The system according to claim 11, wherein the matching module is further configured to apply the learned matching model to predict the matching results of the entity pairs received from the blocking module.

13: The system according to claim 10, comprising a labelling function selection module for selecting the subset of labelling functions, wherein the labelling function selection module is configured to select the subset of labelling functions based on performance characteristics of the machine learning model achieved over a subset of entity pairs annotated with labels based on domain knowledge.

14: The system according to claim 10, further comprising an uncertainty estimation module configured to:
estimate an uncertainty of all entity pairs in both a learning phase and a prediction phase,
jointly select a number of entity pairs with an uncertainty exceeding a predefined threshold from both a model generation phase and a prediction phase and from both the blocking module and the matching module; and
request user annotations for the selected entity pairs from a domain expert.

15: A tangible, non-transitory computer-readable medium having instructions stored thereon which, upon being executed by one or more processors, alone or in combination, provide for execution of a method of identifying entities from different data sources as matching entity pairs that refer to a same real-world object, the method comprising:
providing a set of labelling functions to determine matching entities and non-matching entities of a source data set and a least one target data set;
selecting, from the provided set of labelling functions, a subset of labelling functions for training machine learning models for a blocking module that aims at filtering out as many unmatched entity pairs as possible without missing any true matches and for a matching module that aims at predicting matching results for remaining entity pairs not filtered out by the blocking module; and
jointly learning both a blocking model for the blocking module and a matching model for the matching module based on available unlabeled entity pairs and the labelling functions of the selected subset of labelling functions.
